(19) United States
(12) Patent Application Publication
(10) Pub. No.: US 2008/0211786 A1
(43) Pub. Date: Sep. 4, 2008

(54) DISPLAY DEVICE

(75) Inventors: Keun-woo PARK, Seoul (KR); Kook-chul Moon, Gyeonggi-do (KR); Pil-mo Choi, Seoul (KR); Chul-ho Kim, Gyeonggi-do (KR); Ho-suk Maeng, Seoul (KR); Sang-hoon Lee, Seoul (KR); Kyung-hoon Kim, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/933,102

(22) Filed: Oct. 31, 2007

(30) Foreign Application Priority Data
Nov. 17, 2006 (KR) 10-2006-0113596

(51) Int. Cl. G06F 3/042

(52) U.S. Cl. 345/175; 345/179

(57) ABSTRACT

A display device, includes: a touch panel which outputs a predetermined enable signal corresponding to an external pressure; a display panel which includes a light detector responding to external light and generating a predetermined electrical signal representing the position of the light; and a panel driver which forms an image corresponding to the electrical signal on the display panel if the enable signal is input.

### CROSS-REFERENCE TO RELATED APPLICATIONS

This application claims priority from Korean Patent Application No. 2006-0113596, filed on Nov. 17, 2006, in the Korean Intellectual Property Office, the disclosure of which is incorporated herein by reference.

### BACKGROUND OF THE INVENTION

1. Field of the Invention

Apparatus and methods consistent with the present invention relate to a display device, and more particularly, to a display device which includes a touch panel.

2. Description of the Related Art

Generally, a touch panel is provided in an uppermost part of a display device to enable a user to select contents displayed on the screen. A display device, which includes a touch panel, has the advantage that an additional input device such as a keyboard or a mouse need not be used.

The accuracy of detecting the location that has been touched is determined by the sensitivity of the touch panel. If the touch panel is touched too lightly to be detected, accuracy of locating the position of the display screen that has been touched is lowered. If the touch panel is touched too vigorously, the surface of the screen may be scratched.

An electrostatic panel which forms an image by using external light such as from a light pen has been used. However, that kind of electrostatic touch panel does not respond when touched by a user, thereby decreasing its applicability.

### SUMMARY OF THE INVENTION

The foregoing and/or other aspects of the present invention can be achieved by providing a display device, comprising: a touch panel which outputs responds to external pressure to output an enable signal; a display panel which includes a light detector that is capable of responding to external light and generating a predetermined electrical signal corresponding to the position of the detected light; and a panel driver which forms an image corresponding to the electrical signal on the display panel if the enable signal is provided.

According to the embodiment of the present invention, the display panel comprises a plurality of pixels, a thin film transistor and a pixel electrode connected with the thin film transistor and a storage electrode forming a maintenance capacitance.

According to the embodiment of the present invention, the light detector comprises a switching element that is driven by light, a first signal line that is connected with the switching element and in parallel with the gate line and a second signal line that is provided in parallel with the data line.

According to the embodiment of the present invention, the electrical signal comprises a current, and the panel driver comprises a current-voltage converter which converts a current into a voltage and outputs a predetermined control value if the converted voltage exceeds a predetermined level.

According to the embodiment of the present invention, the current-voltage converter comprises a first current-voltage converter that is connected with the first signal line and a second current-voltage converter that is connected with the second signal line.

According to the embodiment of the present invention, the display panel comprises a calculator that outputs a control signal corresponding to the position information if the first current-voltage converter and the second current-voltage converter output the control value.

According to the embodiment of the present invention, the control value comprises a high value and the calculator comprises a NAND gate circuit.

According to the embodiment of the present invention, the control value comprises a low value and the calculator comprises a NOR gate circuit.

According to the embodiment of the present invention, the switching element comprises a PN junction diode.

According to the embodiment of the present invention, the PN junction diode comprises a first electrode, a second electrode, and a semiconductor layer having a P+ region, an N+ region and an intrinsic silicon region formed between the P+ region and the N+ region.

According to the embodiment of the present invention, the storage electrode receives a positive voltage, and the N+ region is electrically connected with the storage electrode.

According to the embodiment of the present invention, the switching element comprises a metal oxide semiconductor (MOS).

According to the embodiment of the present invention, the touch panel comprises a first panel and a second panel supplied with power at respective levels one of which may be at ground level.

According to the embodiment of the present invention, the light comprises infrared rays.

According to the embodiment of the present invention, the display device further comprises a light pen that emits the infrared rays.

According to the embodiment of the present invention, the display panel comprises a first substrate having pixels, a second substrate and a liquid crystal layer formed between the first substrate and the second substrate.

According to the embodiment of the present invention, the display panel further comprises a light emitting layer formed on the pixels.

### BRIEF DESCRIPTION OF THE DRAWINGS

The above and/or other aspects of the present invention will become apparent and more readily appreciated from the following description of the exemplary embodiments, taken in conjunction with the accompany drawings in which:

FIG. 1 is a schematic view of a display device according to a first exemplary embodiment of the present invention;

FIG. 2 is a plan view of a display panel of the display device according to the first exemplary embodiment of the present invention;

FIG. 3 is a sectional view of the display panel of the display device according to the first exemplary embodiment of the present invention, taken along line III-III in FIG. 2;

FIG. 4 is a control block diagram of the display device according to the first exemplary embodiment of the present invention;

FIG. 5 is a table which explains a calculator of the display device according to the first exemplary embodiment of the present invention; and

FIG. 6 is a sectional view of a display panel of a display device according to a second exemplary embodiment of the present invention.

### DETAILED DESCRIPTION OF EMBODIMENTS

Hereinafter, embodiments of the present invention will be described with reference to accompanying drawings, wherein like numerals refer to like elements and repetitive descriptions will be avoided as necessary.

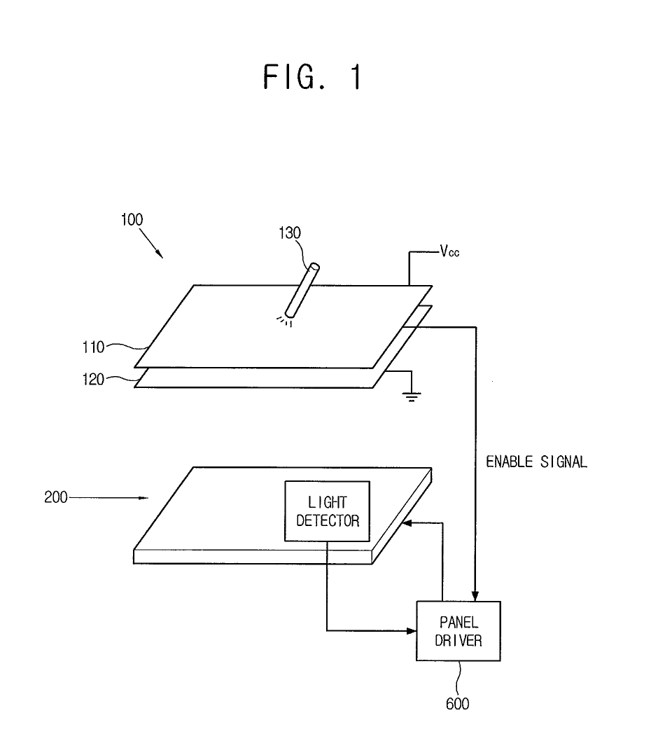

FIG. 1 is a schematic view of a display device according to a first exemplary embodiment of the present invention.

As shown therein, the display device according to the first exemplary embodiment of the present invention includes a touch panel 100, a display panel 200 that is provided behind the touch panel 100 and a light detector and a panel driver 600 which are provided in the display panel 200.

The touch panel 100 includes a first panel 110, a second panel 120 which faces the first panel 110. A light pen 130 may be used. If a predetermined pressure is applied to a surface of the touch panel 100, an enable signal is output to the panel driver 600. A conventional touch panel responds to a surface-applied pressure, and outputs position information to the panel driver 600. According to the first exemplary embodiment of the present invention, the light detector (to be described later) transmits an electrical signal corresponding to an input signal.

The first panel 110 and the second panel 120 receive electric power at different levels, one of which may be ground level. Illustratively, the first panel 110 is connected with a predetermined power terminal which has a first level while the second panel 120 is connected with a ground terminal which has a second level, 0V. First panel 110 is connected with panel driver 600 and outputs a predetermined analog signal corresponding to power of the first level to the panel driver 600 if the touch panel 100 is not pressed.

If a predetermined pressure is applied to the first panel 110 and the second panel 120 is connected to ground, the analog signal is adjusted to be output from the first panel 110 to panel driver 600. The adjusted analog signal becomes an enable signal to activate the electrical signal of the light detector of display panel 200. The light pen 130 advantageously emits infrared rays that are detectable by the light detector of display panel 200.

The light pen 130 may apply a predetermined pressure to the touch panel 100, and thus a user may use the light pen 130 to select an image displayed on the display panel 200 or input texts or symbols, and sense a touch sensibility. That is, the display device according to the present invention accurately controls the image through light emitted by the light pen 130 and allows the light pen 130 to move on the touch panel 100, thereby enabling a user to feel the touch sensibility. The wavelength of light emitted by the light pen 130 ranges from roughly 800 nm to 1000 nm, of which infrared rays excite an intrinsic silicon region (to be described later) to generate a current. The wavelength of the light emitted by the light pen 130 is not limited to the foregoing range, and may be determined in consideration of the maximum efficiency of the light detector responding to light. Alternatively, ultraviolet rays, infrared rays, or visual rays may be accepted. The use of a light pen 130 is not mandatory.

The display panel 200 displays an image with a plurality of pixels, and includes the light detector responding to external light. The light detector responds to the external light and generates the predetermined electrical signal having the position information of the light.

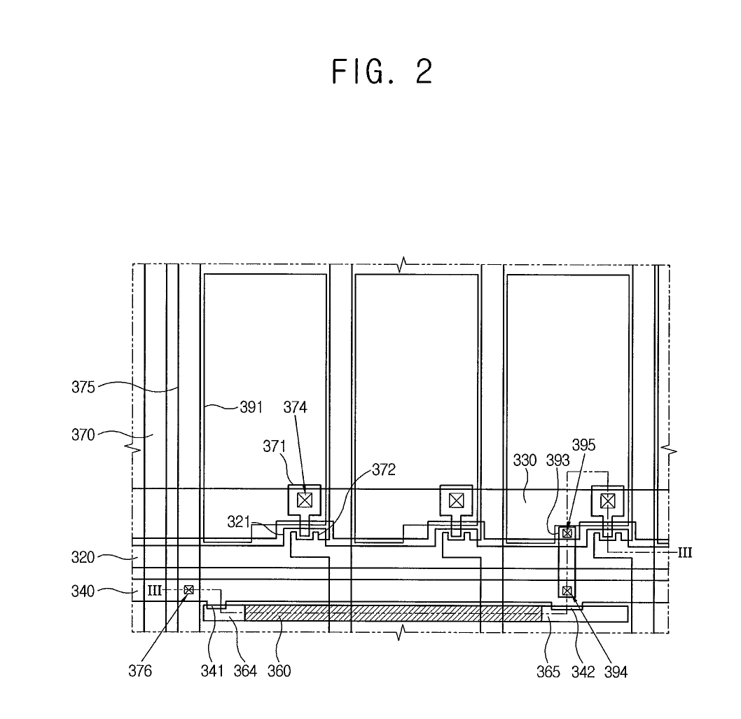

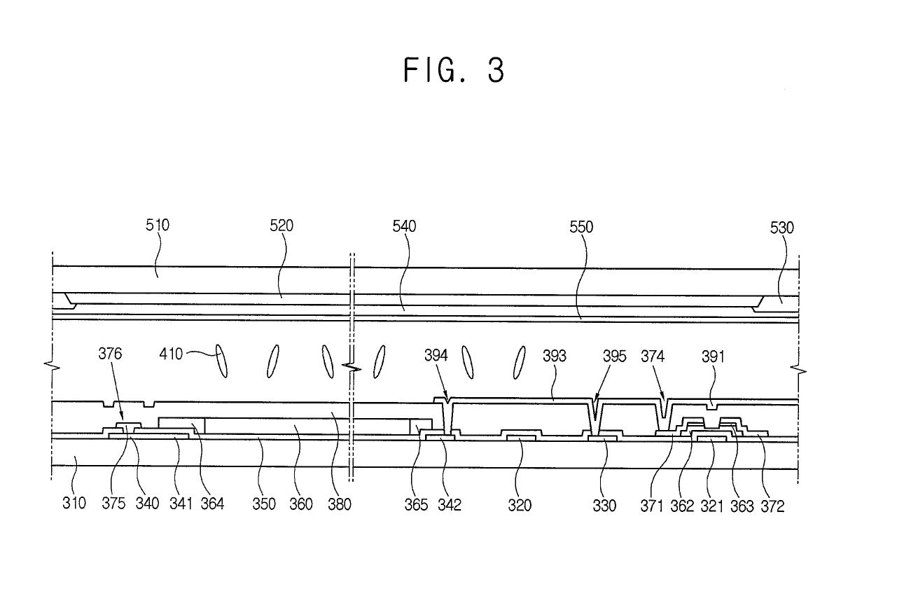

Hereinafter, the display panel 200 and the light detector will be described in detail with reference to FIGS. 2 and 3. FIG. 2 is a plan view of the display panel 200 of the display device according to the first exemplary embodiment of the present invention. FIG. 3 is a sectional view of the display panel 200, taken along line III-III in FIG. 2.

The display panel 200 according to the first exemplary embodiment of the present invention is a liquid crystal display panel which includes a first substrate 310 formed with a plurality of pixels, a second substrate 510 facing the first substrate 310 and a liquid crystal layer 410 interposed between the first substrate 310 and the second substrate 510.

Gate wires 320, 321, 330, 340, 341 and 342 are formed on insulating substrate 310. The gate wires 320, 321, 330, 340, 341 and may include single or double metal layers. The gate wires 320, 321, 330, 340, 341 and 342 include a gate line 320 which is elongated in a transverse direction, a gate electrode 321 which extends from the gate line 320, a storage electrode line 330 which overlaps a pixel electrode 391 and forms a maintenance capacitance, a first signal line 340 which is formed along the gate line 320, and a first electrode 341 and a second electrode 342 which extend from the first signal line 340. The gate electrode 321 corresponds to a control terminal of a thin film transistor. The first and second electrodes 341 and 342 correspond to opposite electrodes of a switching element as the light detector which, according to the first exemplary embodiment of the present invention, includes a PN junction photo diode having a first electrode 341 connected with P+ region 364 and a second electrode 342 connected with an N+ region 365.

The storage electrode line 330 according to the first exemplary embodiment of the present invention is arranged along the gate line 320. The storage electrode line 330 may receive a common voltage that is supplied to a common electrode 550, at various levels. According to the first exemplary embodiment of the present invention, the storage electrode line 330 receives a positive voltage of 0V to 5V.

A gate insulating layer 350 including silicon nitride (SiNx) covers the gate wires 320, 321, 330, 340, 341 and 342 on the first insulating substrate 310.

A semiconductor layer 362 including semiconductor such as amorphous silicon is formed on the gate insulating layer 350 of the gate electrode 321 while an ohmic contact layer 363 including n+ hydrogenated amorphous silicon highly doped with silicide or an n-type dopant is formed on the semiconductor layer 362.

The P+ region 364 highly doped with a p-type dopant is formed on the first electrode 341. The N+ region 365 highly doped with an n-type dopant is formed on the second electrode 342. An intrinsic silicon region 360 including amorphous silicon is formed on the gate insulating layer 350 disposed between the P+ region 364 and the N+ region 365.

The intrinsic silicon region 360 is formed along the first signal line 340 and in the same layer as the semiconductor layer 362 on the gate electrode 321. The intrinsic silicon region 360 may include amorphous silicon or poly silicon. The intrinsic silicon region 360 responds to infrared rays emitted by the light pen 130, and generates a current between the P+ region 364 and the N+ region 365 to be supplied to the first signal line 340 and a second signal line 375 (to be described later). Intrinsic silicon provides the maximum amount of output current when receiving infrared rays, a light with wavelength ranging from roughly 800 nm to 1000 nm. That is, the intrinsic silicon provides the maximum response when receiving infrared rays, i.e., the ratio of the output current to the amount of input light. The material of the silicon region may vary depending on the wavelength range of the light emitted to the display panel 200.

The P+ region 364 and the N+ region 365 are formed by depositing the intrinsic silicon region 360 and then doping a dopant on a predetermined region with a mask.

Data wires 370, 371, 372 and 375 are formed on the intrinsic silicon region 360, the ohmic contact layer 363, the P+ region 364, the N+ region 365 and the gate-insulating layer 350. The data wires 370, 371, 372 and 375 may also include single or multiple metal layers. The data wires 370, 371, 372 and 375 include a data line 370 which is provided in a vertical direction and crosses the gate line 320 to form the pixels, a source electrode 371, a drain electrode 372 which is separated from the source electrode 371 and formed on the ohmic contact layer 363 opposite to the source electrode 371 and the second signal line 375 which is formed along the data line 370.

The drain electrode 372 is branched from the data line 370 and shaped like a U-letter. The source electrode 371 is connected with the pixel electrode 391 through a contact hole 374.

The second signal line 375 crosses the first signal line 340, and is electrically connected with the first signal line 340 through a contact hole 376 that is formed on a crossing region. The current flows from the intrinsic silicon region 364 to the first and second signal lines 340 and 375. The position information on the outputted current refers to position information on the light detector.

A passivation layer 380 is formed on the data wires 370, 371, 372 and 375 and the semiconductor layer 362 that is not covered by the data wires 370, 371, 372 and 375. Contact holes 374, 394 and 395 are formed in the passivation layer 380 to expose the source electrode 362, the storage electrode line 330 and the second electrode 342 of the PN junction diode therethrough.

The pixel electrode 391 and a bridge electrode 393 that connects the storage electrode line 330 and the second electrode 342 are formed on the passivation layer 380. The pixel electrode 391 typically includes a transparent conductive material such as indium tin oxide (ITO), indium zinc oxide (IZO), and other known conductive materials in the art.

As the second electrode 342 is connected with the storage electrode line 330 by the bridge electrode 393, the second electrode 342 receives the positive voltage that is supplied to the storage electrode line 330. That is, the N+ region 365 receives the positive voltage, thereby applying a reverse bias to the PN junction diode. The reverse bias is typically applied to the photo diode to generate a current only when receiving light. The reverse bias applied to the N+ region 365 strengthens an electromagnetic field between the P+ region 364 and the N+ region 365 and moves much carriers if the intrinsic silicon region 360 responds to infrared rays.

The light detector, according to the first exemplary embodiment of the present invention, includes a PN junction diode that has a P+ region 364 and an N+ region 365, an intrinsic silicon region 360, a first electrode 341, a second electrode 342, a first signal line 340 and a second signal line 375. The intrinsic silicon region 360 responds to infrared rays and generates the current as the electrical signal. The generated current is transmitted to the first signal line 340 and the second signal line 375 to supply the position information of the light detector to the panel driver 600.

According to another exemplary embodiment of the present invention, the light detector may include other elements than the PN junction diode. The light detector may include a metal oxide semiconductor (MOS) such as a thin film transistor or other elements that detect light and output a predetermined electrical signal.

Hereinafter, the second substrate 500 will be described.

A black matrix 520 is formed on a second insulating substrate 510. The black matrix 520 generally defines red, green and blue filters and prevents light from being emitted to the thin film transistor in the first substrate 300. The black matrix 520 typically includes a photosensitive organic material added with a black pigment. The black pigment includes carbon black, titanium oxide, and other known materials in the art.

A color filter layer 530 includes red, green and blue filters that are repeatedly formed between the black matrixes 520. The color filter layer 530 assigns color to light emitted from a backlight unit (not shown) and traveling the liquid crystal layer 400. The color filter layer 530 typically includes a photosensitive organic material. The color filter layer 530 may be formed on the first substrate 300 other than the second substrate 500, and may be removed depending on a driving type of the backlight unit.

An overcoat layer 540 is formed on the color filter layer 530 and the black matrixes 520 that are not covered by the color filter layer 530. The overcoat layer 540 makes the color filter layer 530 planar and protects the color filter layer 530. The overcoat layer 540 may include acrylic epoxy.

The common electrode 550 is formed on the overcoat layer 540. The common electrode 550 includes a transparent conductive material such as indium tin oxide (ITO), indium zinc oxide (IZO), and other known materials in the art. The common electrode 550 supplies a voltage to the liquid crystal layer 400, together with the pixel electrode 391 of a thin film transistor substrate.

The liquid crystal layer 400, which includes liquid crystal molecules 410, is disposed between the first and second substrates 300 and 500.

According to another exemplary embodiment of the present invention, the semiconductor layer 362 of the thin film transistor may include poly silicon.

According to another exemplary embodiment of the present invention, more semiconductor layers 362 may be formed on the storage electrode line-formed region to form the maintenance capacitance together with the storage electrode line 330.

The pixels may further include a reflection electrode other than the pixel electrode 391 including the transparent conductive material like the first exemplary embodiment of the present invention. A predetermined cutting pattern may be formed in the pixel electrode 391 and the common electrode 550.

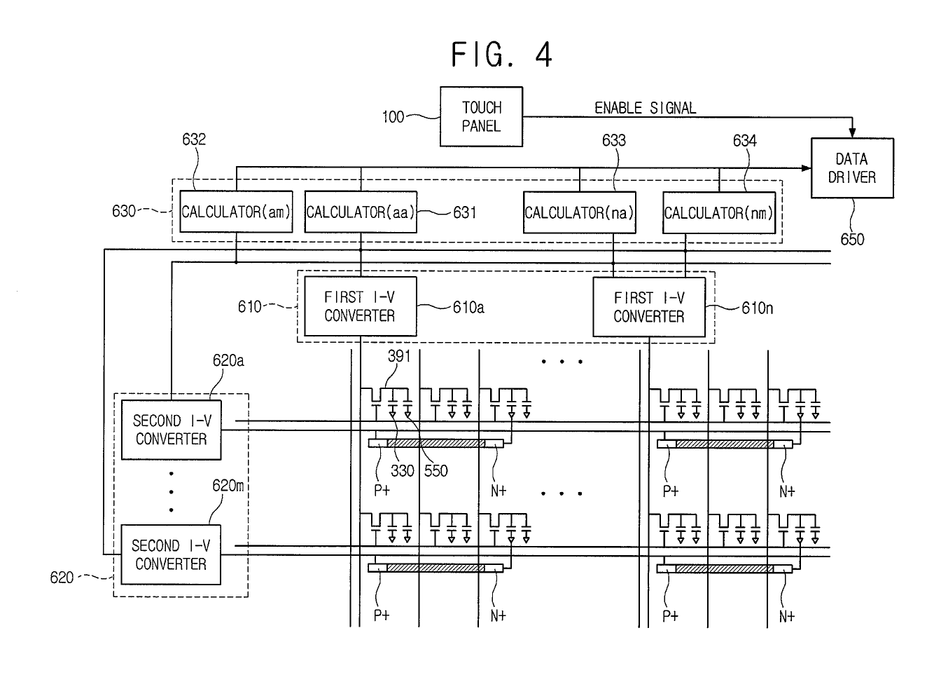

FIG. 4 is a control block diagram of the display device according to the first exemplary embodiment of the present invention. Hereinafter, the panel driver 600 that is connected with the light detector will be described with reference to FIG. 4.

As shown therein, the panel driver 600 includes current-voltage converters 610 and 620, a calculator 630 which is connected with the current-voltage converters 610 and 620, and a data driver 650 which displays an image on the display panel 200 according to a control signal outputted by the calculator 630.

The current-voltage converters 610 and 620 include a first current-voltage converter 610 which is connected with the first signal line 340, and a second current-voltage converter 620 which is connected with the second signal line 375, to convert the current inputted by the first and second signal lines 340 and 375 into a voltage.

The light detector is not formed in every pixel. Instead, a single light detector is formed across three pixels at a predetermined interval. The interval of the light detector is adjusted depending on a diameter of the light pen 130. For example, if the radius of the light pen 130 is approximately 0.8 mm, the light detector may be formed at an interval of every 2 mm², which may be set according to the detection accuracy and the size of the display panel 200. The first current-voltage converter 610 is plurally provided and connected with the first signal line 340 formed with the light detector. The plurality of second current-voltage converters 620 is also connected with the second signal line 375.

The current-voltage converters 610 and 620 convert the inputted current into voltage, and output a predetermined control value to the calculator 630 if the converted voltage exceeds a predetermined level. The current-voltage converters 610 and 620 output the control value only if the voltage is above the predetermined level, considering a small current generated by neighboring light detectors other than the current by infrared rays or the likelihood of a leakage current.

A single first current-voltage converter 610 is connected with a single second current-voltage converter 620. The first current-voltage converter 610 and the second current-voltage converter 620 connected as a pair are connected with a single calculator 630. As shown therein, an “a”th first current-voltage converter 610a and an “a”th second current-voltage converter 620a are connected with a first calculator “aa” 631 while the “a”th first current-voltage converter 610a and an “m”th second current-voltage converter 620m are connected with a second calculator “am” 632. That is, the “n” pieces of first current-voltage converter 610 and the “m” pieces of second current-voltage converter 620 provide the “n×m” pieces of calculators 630 totally.

The respective calculators 630 output a control signal corresponding to the position information to the data driver 650 only if the first current-voltage converter 610 and the second current-voltage converter 620 output the control value. That is, the calculators 630 do not output the control signal if receiving the control value from one of the first current-voltage converter 610 and the second current-voltage converter 620.

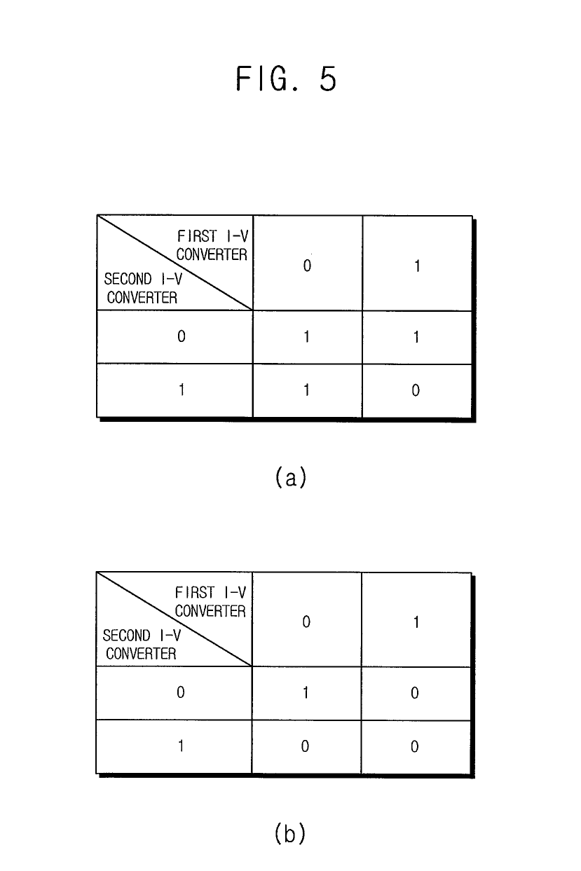

FIG. 5 is a table to explain the calculator 630 of the display device according to the first exemplary embodiment of the present invention. The calculator 630 may include a NAND gate as shown in (a) or a NOR gate as shown in (b). The NAND gate is connected with the first and second current-voltage converters 610 and 620 which output a high signal as the control value if the converted voltage exceeds the predetermined level. That is, the calculators 630 output a low control signal 0 to the data driver 650 only if the two inputted control values are the high signal 1. If the inputted control signal is 0, the data driver 650 determines that the light detector outputs the control signal, and controls the image.

Conversely, the NOR gate is connected with the first and second current-voltage converters 610 and 620 which output a low signal as the control value if the converted voltage exceeds the predetermined level. That is, the calculators 630 output a high signal 1 to the data driver 650 only if the two inputted control values are the low signal 0. If the inputted control signal is 1, the data driver 650 determines that the light detector outputs the control signal. The data driver 650 may determine the position of the light detector through the calculators 630 outputting the control signal.

The data driver 650 forms the image corresponding to the control signal on the display panel 200 if receiving an enable signal activating the control signal from the touch panel 100 together with the control signal outputted from the calculators 630.

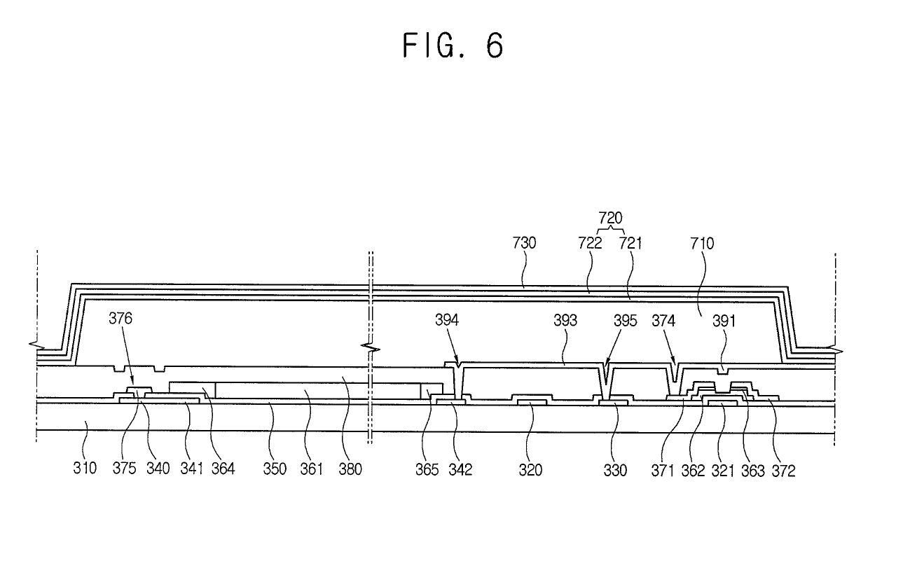

FIG. 6 is a sectional view of a display panel of a display device according to a second exemplary embodiment of the present invention.

The display device according to the second exemplary embodiment of the present invention includes an organic light emitting diode (OLED) which has an organic layer 720 formed on a pixel electrode 391.

A wall 710 is formed between the pixel electrodes 391. The wall 710 divides the pixel electrodes 391 and defines a pixel region. The wall 710 includes a photosensitive material such as acrylic resin, or polyimide resin which is heat resistant and solvent resistant, or an inorganic material such as SiO2 and TiO2. The wall 710 may include a double layer structure having an organic layer and an inorganic layer.

The organic layer 720 is formed on the pixel electrodes 391 that are not covered by the wall 710. The organic layer 720 includes a hole-injecting layer 721 and an organic light emitting layer 722. The hole-injecting layer 721 may employ an amine derivative which is highly fluorescent, e.g., a triphenyl diamine derivative, a styryl amine derivative, and an amine derivative having an aromatic condensed ring.

The organic layer 720 may further include a hole transport layer (not shown) between the hole injecting layer 721 and the organic light emitting layer 722, and an electron transport layer (not shown) and/or an electron injecting layer (not shown) on the organic light emitting layer 722.

The organic light emitting layer 722 includes a low molecular material emitting white light, which is deposited by using an open mask. The light emitted by the organic light emitting layer 722 is assigned a red, green or blue color while passing through a color filter layer formed in the first substrate 300.

A common electrode 730 is disposed on the wall 710 and the organic light emitting layer 722. The common electrode 730 is called a cathode, which supplies an electron to the organic light emitting layer 722. The common electrode 730 may be formed by stacking a calcium layer and an aluminum layer. A hole transmitted from the pixel electrodes 391 and an electron transmitted from the common electrode 730 are combined into an exciton on the organic light emitting layer 722, thereby emitting light during a deactivation process of the exciton.

As described above, the present invention provides a display device which has enhanced accuracy and touch sensibility.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display device, comprising:
a touch panel which outputs a predetermined enable signal corresponding to an external pressure;
a display panel which includes a light detector responding to external light and generating a predetermined electrical signal representing the position of the light; and
a panel driver which forms an image corresponding to the electrical signal on the display panel if the enable signal is input.

2. The display device according to claim 1, wherein the display panel comprises a plurality of pixels each of which has a gate line and a data line, a thin film transistor connected with the gate line and the data line, a pixel electrode connected with the thin film transistor and a storage electrode forming a maintenance capacitance.

3. The display device according to claim 2, wherein the light detector comprises a switching element which is driven by light, a first signal line which is connected with the switching element and in parallel with the gate line and a second signal line which is provided in parallel with the data line.

4. The display device according to claim 3, wherein the electrical signal comprises a current, and the panel driver comprises a current-voltage converter which converts a current into a voltage and outputs a predetermined control value if the converted voltage exceeds a predetermined level.

5. The display device according to claim 4, wherein the current-voltage converter comprises a first current-voltage converter which is connected with the first signal line and a second current-voltage converter which is connected with the second signal line.

6. The display device according to claim 5, wherein the display panel comprises a calculator which outputs a control signal corresponding to the position information if the first current-voltage converter and the second current-voltage converter output the control value.

7. The display device according to claim 6, wherein the control value comprises a high value and the calculator comprises a NAND gate circuit.

8. The display device according to claim 6, wherein the control value comprises a low value and the calculator comprises a NOR gate circuit.

9. The display device according to claim 3, wherein the switching element comprises a PN junction diode.

10. The display device according to claim 9, wherein the PN junction diode comprises a first electrode, a second electrode, and a semiconductor layer having a P+ region, an N+ region and an intrinsic silicon region formed between the P+ region and the N+ region.

11. The display device according to claim 10, wherein the storage electrode receives a positive voltage, and the N+ region is electrically connected with the storage electrode.

12. The display device according to claim 3, wherein the switching element comprises a metal oxide semiconductor (MOS).

13. The display device according to claim 1, wherein the touch panel comprises a first panel and a second panel supplied with respective power levels.

14. The display device according to claim 13, wherein one of the respective power levels is ground level.

15. The display device according to claim 1, wherein the light comprises infrared rays.

16. The display device according to claim 15, further comprising a light pen which emits the infrared rays.

17. The display device according to claim 2, wherein the display panel comprises a first substrate having pixels, a second substrate and a liquid crystal layer formed between the first substrate and the second substrate.

18. The display device according to claim 2, wherein the display panel further comprises a light emitting layer formed on the pixels.
